(19) United States
(12) Patent Application Publication
(10) Pub. No.: US 2008/0084520 A1
(43) Pub. Date: Apr. 10, 2008

(54) BACKLIGHT ASSEMBLY, LIQUID CRYSTAL DISPLAY HAVING THE SAME AND METHOD THEREOF

(75) Inventors: Young-joo NAM, Daegu (KR); Sang-hoon PARK, Yongin-si (KR); Jae-chang CHOI, Yongin-si (KR); Dong-gyun RA, Asan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD.,, Suwon-si (KR)

(21) Appl. No.: 11/866,465

(22) Filed: Oct. 3, 2007

(30) Foreign Application Priority Data
Oct. 9, 2006 (KR) 1020060097964

(51) Int. Cl. G02F 1/13357; F21V 8/00; H01J 9/00

(52) U.S. Cl. 349/65; 362/612; 445/24

(57) ABSTRACT

A backlight assembly including a light emitting diode (“LED”) assembly including a plurality of LED devices, a mold frame receiving a light guiding plate and including a coupling portion disposed at a side of a rear surface of the mold frame, and a sensor combined with the coupling portion and sensing an amount of light emitted from the plurality of LED devices.

This application claims priority to Korean Patent Application No. 10-2006-0097964 filed on Oct. 9, 2006, and all the benefits accruing therefrom under 35 U.S.C. §119, the contents of which are incorporated herein by reference in its entirety.

### BACKGROUND OF THE INVENTION

1. Field of the Invention

The present invention relates to a backlight assembly, a liquid crystal display having the same and method thereof, and more particularly, to a backlight assembly which reduces an overall volume of a liquid crystal display, and a liquid crystal display having the same.

2. Description of the Related Art

Liquid crystal displays (“LCDs”) are one of the most commonly used flat panel displays. An LCD, which includes two panels having a plurality of electrodes thereon and a liquid crystal layer interposed between the two panels, controls the transmittance of incident light by applying voltages to the electrodes to rearrange liquid crystal molecules of the liquid crystal layer.

The LCD apparatus displays images by controlling the transmittance of the incident light by changing the orientation and intensity of an electrical field caused by the liquid crystal molecules. Therefore, the LCD apparatus requires a light source that provides an LCD panel with light to display images. The LCD employs a light source such as a light emitting diode (“LED”), a cold cathode fluorescent lamp (“CCFL”), or a flat fluorescent lamp (“FFL”).

Conventional LCDs have employed a CCFL as a light source. LCDs employing an FFL or an LED as a light source have been widely developed. In particular, in view of power consumption and luminance, LCDs employing an LED having a relatively high luminance while consuming small power.

White LEDs are used in electronic equipment such as a notebook personal computer (“PC”), etc. The white LEDs may, however, deteriorate color reproducibility. To overcome this problem, a light source of high color reproducibility, i.e., natural color reproducibility, can be implemented using R, G and B (Red, Green and Blue) LEDs. In order to implement high color reproducibility, it is important to control the amount of light emitted from each of the R, G and B LEDs. To this end, a senor sensing the amount of light emitted from each of the R, G and B LEDs is employed.

In a laptop computer monitor or a television (“TV”) screen, a sensor may be attached to a lateral surface of a light guiding plate. However, a light guide plate may not suitable for a relatively small-sized electronic device, such as a notebook PC or a cellular phone, due to a spatial limitation. In the case of a notebook PC monitor, for example, since the size of a sensor is larger than the thickness of a light guiding plate, the overall volume of an LCD is likely to increase.

### BRIEF SUMMARY OF THE INVENTION

Exemplary embodiments provide a backlight assembly which can reduce an overall thickness and volume of a liquid crystal display.

Exemplary embodiments provide a liquid crystal display (“LCD”) device including the backlight assembly which can reduce an overall thickness or volume of a liquid crystal display.

In an exemplary embodiment, there is provided a backlight assembly including a light emitting diode (“LED”) assembly including a plurality of LED devices, a mold frame receiving a light guiding plate and including a coupling portion disposed at a side of a rear surface of the mold frame, and a sensor combined with the coupling portion and sensing an amount of light emitted from the plurality of LED devices.

In an exemplary embodiment, there is provided a liquid crystal display (“LCD”) including an LCD panel assembly including an LCD panel displaying image information and a first printed circuit board (“PCB”) connected to the LCD panel to provide the image information to the LCD panel, a light emitting diode (“LED”) assembly providing light to the LCD panel and including a plurality of LED devices, a light guiding plate providing a propagation path of the light, a mold frame receiving the light guiding plate and including a coupling portion disposed at a side of a rear surface of the mold frame, and a sensor combined with the coupling portion, sensing an amount of the light emitted from the plurality of LED devices, and g the amount of sensed light being transmitted to the first PCB.

In an exemplary embodiment, there is provided a method of forming a backlight assembly the method comprising forming a light emitting diode (“LED”) assembly including a plurality of LED devices, forming a mold frame including a hole disposed at an edge of the mold frame and disposing a sensor in the hole of the mold frame and combining the sensor with the mold frame, the sensor sensing an amount of light emitted from the plurality of LED devices.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exploded perspective view of an exemplary embodiment of a liquid crystal display according to the present invention;

FIG. 2 is a perspective view illustrating an exemplary embodiment of a mold frame according to the present invention and a printed circuit board;

FIG. 3 is a cross-sectional view taken along line A-A′ of FIG. 1;

FIGS. 4A and 4B are rear perspective views illustrating an assembled state of the mold frame and the printed circuit board shown in FIG. 2;

FIG. 5 is a rear perspective view of portion “B” of FIGS. 4A and 4B;

FIG. 6 is a perspective view illustrating another exemplary embodiment of a mold frame according to the present invention and a printed circuit board;

FIG. 7 is a cross-sectional view of an exemplary embodiment of a liquid crystal display including the mold frame shown in FIG. 6;

FIG. 8 is a rear perspective view illustrating an assembled state of the mold frame and the printed circuit board shown in FIG. 6;

FIG. 9 is a perspective view illustrating another exemplary embodiment of a mold frame according to the present invention and a flexible printed circuit board;

FIGS. 10A and 10B are rear perspective views illustrating an assembled state of the mold frame shown and the flexible printed circuit board shown in FIG. 9;

FIG. 11 is a cross-sectional view of an exemplary embodiment of a liquid crystal display including the mold frame shown in FIG. 9;

FIGS. 12A and 12B is a rear perspective view illustrating an assembled state of the mold frame and the flexible printed circuit board shown in FIG. 9;

FIG. 13 is a rear perspective view of portion “D” of FIG. 12; and

FIG. 14 is an exploded perspective view of another exemplary embodiment of a liquid crystal display according to the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower relative to other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

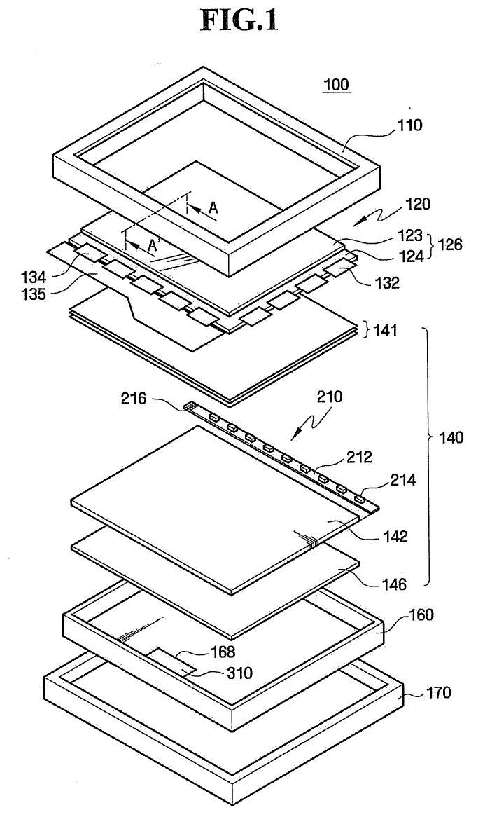

An exemplary embodiment of a liquid crystal display (“LCD”) according to the present invention will now be described in detail with reference to FIG. 1.

FIG. 1 is an exploded perspective view of an exemplary embodiment of an LCD 100. Referring to FIG. 1, the LCD 100 includes an LCD panel assembly 120, a backlight assembly 140, a top chassis 110, and a bottom chassis 170.

The LCD panel assembly 120 includes an LCD panel 126 including a thin film transistor (“TFT”) substrate 124 and a common electrode substrate 123, a liquid crystal layer (not shown), a gate tape carrier package (TCP) 132, a data TCP 134, and a first printed circuit board (“PCB”) 135.

The TFT substrate 124 of the LCD panel 126 includes gate lines (not shown), data lines (not shown), a TFT array, and pixel electrodes. The common electrode substrate 123 of the LCD panel 126 includes black matrixes and a common electrode and is arranged to face the TFT substrate 124. The LCD panel 126 serves to display image information.

The gate TCP 132 is connected to the gate lines formed on the TFT substrate 124 and the data TCP 134 is connected to the data lines formed on the TFT substrate 124, respectively.

Driving components for driving gate driving signals applied to the gate TCP 132 and data driving signals applied to the data TCP 134 are mounted on the first PCB 135. The first PCB 135 is connected to the LCD panel 126 and provides image information.

The backlight assembly 140 includes optical sheets 141, a light guiding plate 142, a light emitting diode (“LED”) assembly 210, and a reflective plate 146.

The light guiding plate 142 guides light provided to the LCD panel assembly 120. In an exemplary embodiment, the light guiding plate 142 is formed of a transparent plastic-series panel, such as including acryl. The light guiding plate 142 functions to change a direction of propagation of light beams emitted from the LED assembly 210 such that the light beams propagate toward the LCD panel 126 placed on the light guiding plate 142.

A variety of patterns for changing the propagation direction of the light beams incident onto the light guiding plate 142, may be formed on a rear surface of the light guiding plate 142. In an exemplary embodiment of a light guiding plate including the patterns, the light guiding plate 142 may be substantially flat and has a substantially uniform thickness across an entire area, thereby evenly illuminating an entire display screen of the liquid crystal panel. However, the invention is not limited to the illustrated type of the light guiding plate and a variety of types of light guiding plates may be employed in the present invention.

As in the illustrated embodiment, the LED assembly 210 is disposed at a side of the light guiding plate 142. The LED assembly 210 is disposed at a sidewall of the light guiding plate 142 corresponding to the first PCB 135. As used herein, “corresponding” is used to indicate corresponding substantially in shape, dimension or in location. For example, the LED assembly 210 is disposed at the sidewall of the light guiding plate 142 that corresponds in location or proximity to the first PCB 135.

The LED assembly 210 includes a flexible PCB 212, a plurality of LED devices 214 connected to the flexible PCB 212, and a connection terminal 216 formed at an end of the flexible PCB 212 and connected to the first PCB 135. The plurality of LED devices 214 include R, G and B LED devices.

In an exemplary embodiment of an LCD having substantially uniform luminance, the plurality of LED devices 214 may be arranged to be separated by a constant interval along the sidewall of the light guiding plate 142. An inverter (not shown) for applying power to the plurality of LED devices 214 may be installed on the first PCB 135 and the inverter is connected to a connector (not shown) to supply power to the LED devices 214.

In the illustrated embodiment, the invention is described with regard to the inverter mounted on the first PCB 135 by way of example, but is not limited to the illustrated exemplary embodiment. In a case where the inverter is mounted on a separate PCB, the LED assembly 210 is connected to the separate PCB.

The reflective plate 146 is disposed on a bottom surface of the light guiding plate 142 and reflects light upward from below the light guiding plate 142. In an exemplary embodiment, the reflective plate 146 reflects the light that is not reflected by fine patterns formed on the rear surface of the light guiding plate 142 toward an exit face of the light guiding plate 142 (e.g., an upper surface), thereby reducing loss of light incident into the LCD panel 126 and enhancing uniformity of light transmitted to the exit face of the light guiding plate 142.

The optical sheets 141 are disposed on the light guiding plate 142 (e.g., on an upper surface) and serve to diffuse and focus light emitting from the light guiding plate 142. The optical sheets 141 may include, but are not limited to, a diffusion sheet, a prism sheet, a protection sheet, etc. The diffusion sheet, disposed between the light guiding plate 142 and the prism sheet, diffuses incident light from the light guiding plate 142, thereby reducing or effectively preventing partial congestion of light.

The prism sheet may include triangular prism patterns formed on a portion or over all of its surface in a predetermined arrangement. In an exemplary embodiment, the prism sheet may include two sheets including prisms alternately arranged at a predetermined angle to focus light diffused by the diffusion sheet in a direction perpendicular to the LCD panel 126. Accordingly, the light that has passed through the prism sheet travels in a direction substantially perpendicular to the LCD panel 126, thereby obtaining brightness uniformity on the protection sheet.

The protection sheet formed on the prism sheet not only serves to protect a surface of the prism sheet but also enhances the diffusion of light to increase the uniformity of light distribution. The configuration of the optical sheets 141 is not limited to the illustrated exemplary embodiment and may be modified in various manners according to the specification of the LCD 100.

The LCD panel assembly 120 is disposed on the optical sheets 141, e.g., the protection sheet, and is housed in the mold frame 160 together with the backlight assembly 140. The mold frame 160 includes four sidewalls formed along edges of a bottom surface so that the backlight assembly 140 and the LCD panel assembly 120 are fixedly received therein. In addition, the mold frame 160 serves to reduce or effectively prevent deformation of the backlight assembly 140, such as bending of multiple sheets of the backlight assembly.

In an exemplary embodiment, the first PCB 135 of the LCD panel assembly 120 is bent to an external side of the mold frame 160 and then disposed on a rear surface of the mold frame 160. Here, the shape of the mold frame 160 may vary according to the way in which the backlight assembly 140 or the LCD panel assembly 120 is received in the mold frame 160.

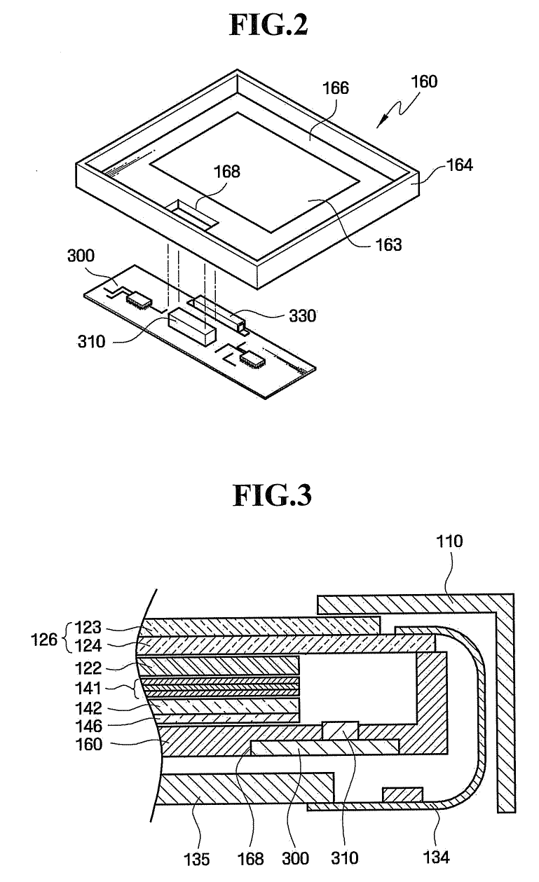

A coupling portion 168 is formed at one side of the rear surface of the mold frame 160. The coupling portion combined with a sensor to sense light emitted from the LED assembly 210, and will later be described in greater detail with reference to FIGS. 2 through 13.

The bottom chassis 170 is disposed adjacent to the bottom surface of the mold frame 160. The top chassis 110 is combined to the bottom chassis 170 so as to cover an upper surface, e.g., a peripheral edge, of the LCD panel assembly 120. A window exposing the LCD panel assembly 120 to the outside is disposed in the upper surface of the top chassis 110.

The top chassis 110 may be combined with the bottom chassis 170 by a hook (not shown) configuration. In one exemplary embodiment, hooks (not shown) may be formed along external sides of sidewalls of the bottom chassis 170 and hook insertion holes (not shown) corresponding to the hooks may be formed along the sidewalls of the top chassis 110. Alternatively, the coupling between the top chassis 110 and the bottom chassis 170 may be achieved in any of a number of ways suitable for the purpose described herein.

FIG. 2 is a perspective view illustrating an exemplary embodiment of a mold frame 160 according to the present invention and a second printed circuit board (“PCB”) 300.

Referring to FIG. 2, the mold frame 160 includes a window 163, sidewalls 164 forming a rectangular frame surrounding lateral sides of an LCD panel 126, a seating portion 166 extending a predetermined length from the internal walls of the rectangular frame to receive the LCD panel 126, and an coupling portion 168 combined with a sensor 310 of the second printed circuit board 300. The coupling portion 168 is formed at one side of the rear surface of the mold frame 160, such as, at a region other than an active area of the LCD panel on the rear surface of the mold frame 160.

The second PCB 300 including the sensor 310 and a plurality of electronic components mounted thereon is combined with the coupling portion 168 formed in the mold frame 160. The sensor 310 senses an amount of light emitted from the LED devices 214 and transmits information about the same to the first PCB 135.

In an exemplary embodiment, a fixing member, such as an adhesive tape (not shown), can be attached to a region other than a sensor area of an upper surface of the second PCB 300, thereby increasing adhesion between the second PCB 300 and the coupling portion 168 of the mold frame 160.

FIG. 3 is a cross-sectional view taken along line A-A′ of FIG. 1.

Referring to FIG. 3, the coupling portion 168 formed in the mold frame 160 is formed in the rear surface of the mold frame 160 and has a stepped configuration to define a space in which the second PCB 300 and the sensor 310 are received by the mold frame 160. The second PCB 300 including the sensor 310 mounted thereon is combined with the coupling portion 168. The sensor 310 is inserted into the coupling portion 168 of the mold frame 160 from a rear side of the mold frame 160.

The sensor 310 senses the amount of light and transmits information such as the amount of sensed light to the first PCB 135 through a first flexible PCB (not shown) connected to a connector (not shown) of the second PCB 300.

A size (e.g., dimension, such as thickness) of a sensor may be greater than the thickness of a light guiding plate. Thus, the overall volume of the LCD may increase. As illustrated in the exemplary embodiment, the coupling portion 168 is formed on the rear surface of the mold frame 160 and the second PCB 300 including the sensor 310 mounted thereon is combined with the coupling portion 168. The second printed circuit board 300 is accommodated by the stepped configuration of the coupling portion 168 of the mold frame 160. Lower surfaces of the second printed circuit board 300 and the mold frame 160 substantially coincide (e.g., form a substantially planar or flat surface) because the coupling portion 168 allows the sensor 310 to be completely inserted into the mold frame 160. Advantageously, an overall thickness and volume of the LCD is reduced.

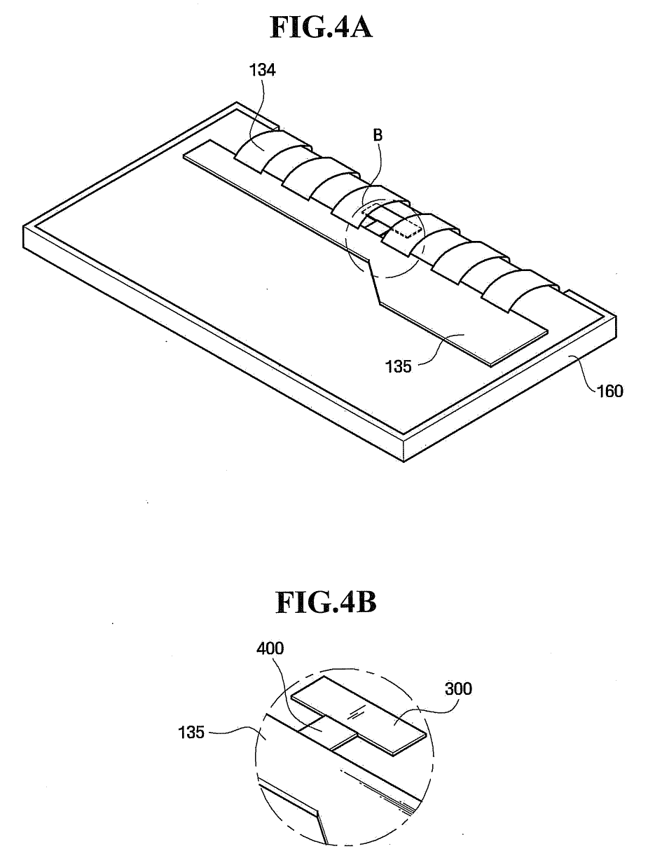

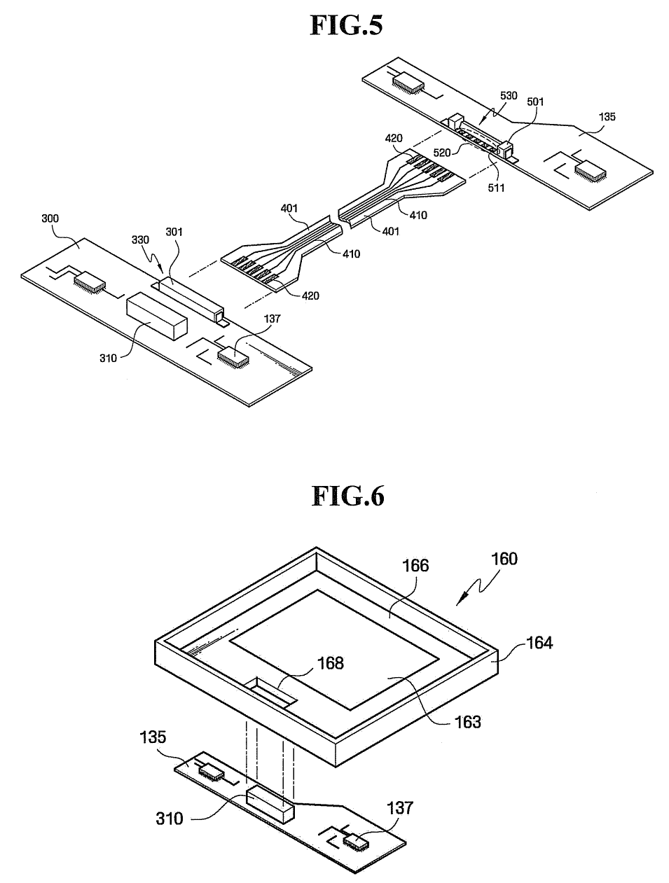

FIGS. 4A and 4B are rear perspective views illustrating an assembled state of the mold frame and the printed circuit board shown in FIG. 2, and FIG. 5 is a rear perspective view of portion “B” of FIGS. 4A and 4B.

Referring to FIGS. 4A, 4B and 5, the second PCB 300 is combined with the coupling portion 168 of the mold frame 160. A first flexible PCB 400 is used in combining the second PCB 300 with the first PCB 135.

Connecting pads 420 formed on the first flexible PCB 400 are connected to connectors 330 and 530 mounted on the second PCB 300 and the first PCB 135, respectively. The connecting pads 420 transmit information relative to the amount of sensed light by the sensor 310 of the second PCB 300 to the first PCB 135 through the first flexible PCB 400.

The first flexible PCB 400 includes conductor patterns formed on a base film 401. The base film 401 may be made of a flexible insulating material such as polyimide. The conductor patterns include wire patterns 410 and connecting pads 420. The wire patterns 410 include a plurality signal lines forming a part of a predetermined circuit. The connecting pads 420 are formed at ends of a first side (e.g., surface) of the base film 401.

In an exemplary embodiment, each of the wire patterns 410 has a width (e.g., taken in a transverse direction of the first flexible printed circuit board) of about 5 to 20 microns (μm). The wire patterns 410 may include a metallic material, such as copper (Cu). In one exemplary embodiment, the wire patterns 410 may be formed by plating tin (Sn), gold (Au), nickel (Ni) or solder on a surface of a Cu foil.

In an exemplary embodiment, the formation of the wire patterns 410 using a Cu foil may be performed by casting, laminating, electroplating, and the like. In the casting method, a liquid base film is applied to a rolled copper foil. In the laminating method, a rolled copper foil is placed on a base film and thermally compressed. In the electroplating method, a copper seed layer is deposited on a base film, the base film is put into an electrolyte solution containing copper dissolved therein, and electricity is applied to the solution to form a copper foil. Here, wires patterned on the copper foil are formed by selectively etching the copper foil through a photolithographic etching process, thereby completing the predetermined circuit.

In an exemplary embodiment, to protect the wire patterns 410 against external shock and corrosive substances, an insulating passivation layer (not shown) may be formed on the wire patterns 410. Solder resist may be used as the insulating passivation layer.

The connecting pads 420 formed on a first surface and at a first end of the base film 401 are portions which are configured to be electrically connected with external circuits. The connecting pads 420 may include a conductive material, such as the same material as the wire patterns 410. The connecting pads 420 of the first flexible PCB 400 may be formed on the first surface at a second end of the base film 401, which is opposite to the first end of the base film 401 to which the external circuit are connected.

The connectors 330 and 530 include bodies 301 and 501, and contact terminals 511 connected with the connecting pads 420 of the first flexible PCB 400. In an exemplary embodiment, the connectors 330 and 530 may include a cover (not shown) covering the contact terminals 511.

The connectors 330 and 530 include a contact portion 520 formed in the bodies 301 and 501. The bodies 301 and 501 may include synthetic resin. The contact terminals 511 of the connectors 330 and 530 are connected with respective connecting pads 420 of the first flexible PCB 400. The connectors 330, 530 are positioned on the second PCB 300 and the first PCB 135, respectively.

Contact terminals (not shown in FIG. 5) of a contact portion (not shown in FIG. 5) formed on the second PCB 300 are combined with the corresponding connecting pads 420 of the first flexible PCB 400 (e.g., at the first end). Likewise, the contact terminals 511 of the contact portion 520 formed on the first PCB 135 are combined with the corresponding connecting pads 420 of the first flexible PCB 400 (e.g., at the second end). In one exemplary embodiment, the contact terminals 511 of the contact portion 520 may include a conductive material and/or may be substantially equally spaced apart from one another.

Hereinafter, an exemplary embodiment of a mold frame and a sensor according to the present invention will be described with reference to FIGS. 6 through 8.

The mold frame and sensor or FIGS. 6 through 8 are substantially the same as in FIGS. 1-5 except that the first PCB 135 including the sensor 310 is combined in the coupling portion 168 formed in the mold frame 160, and the same explanations will not be repeated.

FIG. 6 is a perspective view illustrating another exemplary embodiment of a mold frame 160 according to the present invention and a first printed circuit board (“PCB”) 135 prior to being combined with each other.

Referring to FIG. 6, the mold frame 160 includes a window 163, sidewalls 164 forming a rectangular frame surrounding lateral sides of an LCD panel 126, a seating portion 166 extending a predetermined length from the internal walls of the rectangular frame to receive the LCD panel 126, and a coupling portion 168 combined with a sensor 310 of the first PCB 135. The coupling portion 168 is formed at one side of the rear surface of the mold frame 160, such as at a region other than an active area of the LCD panel on the rear surface of the mold frame 160.

The first PCB 135 including the sensor 310 and a plurality of electronic components mounted thereon is combined with the coupling portion 168 formed in the mold frame 160. As illustrated in FIGS. 6-8, the first PCB 135 including the sensor 310 is connected (e.g., directly) to the LCD panel 126. In contrast, the second PCB 300 including the sensor 310 in FIGS. 2-5 is connected to the LCD panel 126 through a separate member, e.g. the first flexible PCB 400.

The sensor 310 senses an amount of light emitted from the LED devices 214 and transmits information relative to the amount of sensed light to sensor driver chips 137 mounted on the first PCB 135. In an exemplary embodiment, a fixing member, such as an adhesive tape (not shown) can be attached to a region other than an area where the sensor is disposed and on an upper surface of the first PCB 135, thereby increasing adhesion between the first PCB 135 and the coupling portion 168 of the mold frame 160.

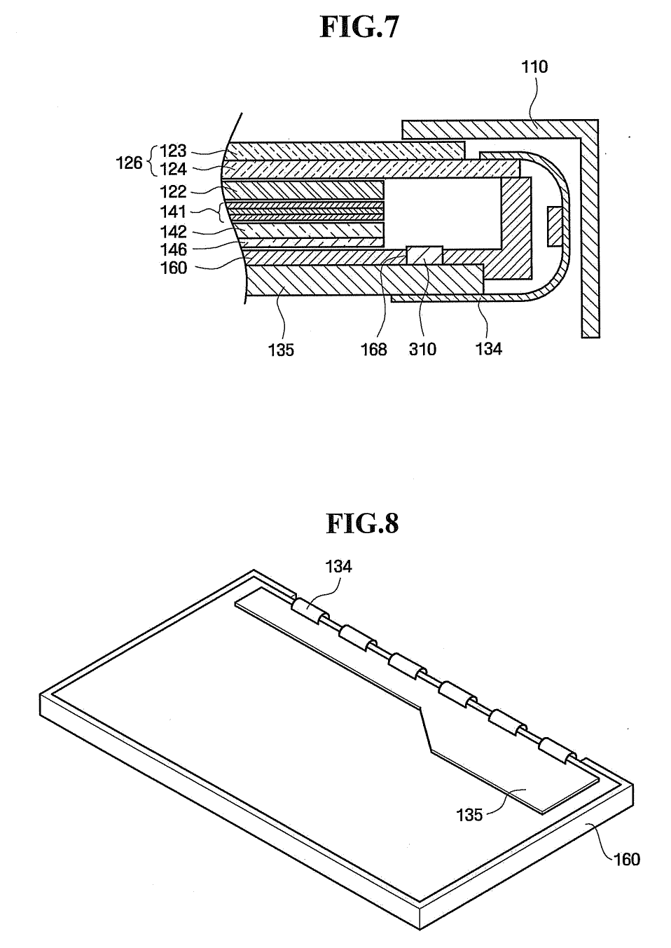

FIG. 7 is a cross-sectional view of an exemplary embodiment of a liquid crystal display including the mold frame shown FIG. 6.

Referring to FIG. 7, the coupling portion 168 formed on the mold frame 160 is formed in the rear surface of the mold frame 160 and has a stepped configuration to define a space in which the first PCB 135 and the sensor 310 are received by the mold frame 160. The first PCB 135 including the sensor 310 mounted thereon is combined with the coupling portion 168.

The sensor 310 senses the amount of light and transmits information such as the amount of sensed light to the sensor driver chips 137 mounted on the first PCB 135.

As illustrated in the exemplary embodiment, the coupling portion 168 is formed on the rear surface of the mold frame 160, which is the same as in FIGS. 1-5, and the first PCB 135 including the sensor 310 mounted thereon is combined with the coupling portion 168 of the mold frame 160. A portion of the first PCB 135 is accommodated by the stepped configuration of the mold frame 160. Advantageously, an overall thickness and volume of the LCD is reduced.

FIG. 8 is a rear perspective view illustrating an assembled state of the mold frame and the printed circuit board shown in FIG. 6.

Referring to FIG. 8, the first PCB 135 is combined with the coupling portion 168 of the mold frame 160. Since the sensor 310 is mounted on the first PCB 135, it is possible for the sensor 310 to transmit information on the amount of light it senses as being emitted from the R, G and LED devices 214 to the sensor driver chips 137 mounted on the first PCB 135.

As in the illustrated embodiment, a first flexible PCB is not necessary to combining the first and second PCBs with each other. Advantageously, a manufacturing cost can be reduced. Further, it is possible to reduce noise that may be generated in wire patterns (410 of FIG. 5) formed in a first flexible PCB (400 of FIG. 5).

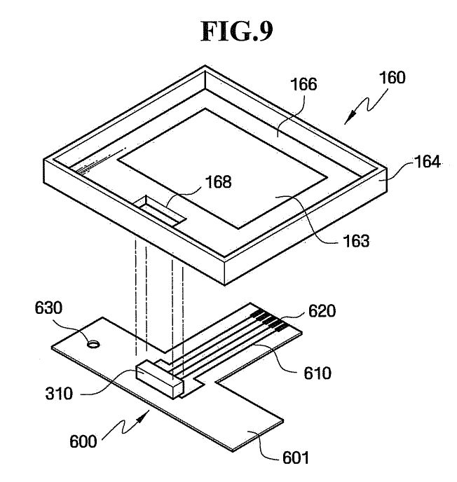

Hereinafter, another exemplary embodiment of a mold frame and a sensor according to the present invention will be described with reference to FIGS. 9 through 13.

The mold frame and the sensor of FIGS. 9 through 13 are substantially the same as in FIGS. 1-5 except that a second flexible PCB including the sensor is combined with a coupling portion formed in a mold frame and a protrusion is formed at one side of the coupling portion, and the same explanations will not be repeated.

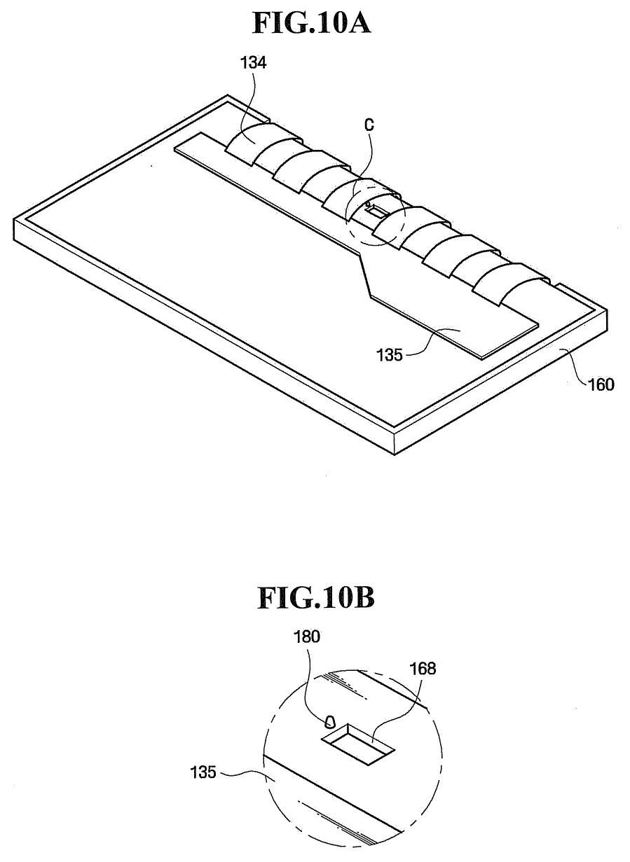

FIG. 9 is a perspective view illustrating another exemplary embodiment of a mold frame 160 according to the present invention and a second flexible printed circuit board (“PCB”) 600, which are in an assembled state, FIG. 10A is a rear perspective views illustrating an assembled state of the mold frame and the flexible PCB shown in FIG. 9 and FIG. 10B is an enlarged portion “C” of FIG. 10A.

Referring to FIG. 9 and FIGS. 10A and 10B, the mold frame 160 includes a window 163, sidewalls 164 forming a rectangular frame surrounding lateral sides of an LCD panel 126, a seating portion 166 extending a predetermined length from the internal walls of the rectangular frame to receive the LCD panel 126, a coupling portion 168 configured to be combined with a sensor 310, and a protrusion 180.

The coupling portion 168 is formed adjacent to a side of the rear surface of the mold frame 160, such as at a region other than an active area of the LCD panel on the rear surface of the mold frame 160. The protrusion 180 is formed at one side of the coupling portion 168 and protrudes from the rear surface of the mold frame 160. The protrusion 180 is combined with an alignment groove 630 formed on the second flexible PCB 600, such as to fix a position of the second flexible PCB 600 when it is connected with the first PCB 135. In an exemplary embodiment, the protrusion 180 protrudes from the mold frame 160 to substantially a same height (e.g., in a direction perpendicular to the rear surface of the mold frame 160) as the thickness of the second flexible PCB 600.

The second flexible PCB 600 is combined with the coupling portion 168 formed in the mold frame 160 and includes the sensor 310 mounted thereon. The sensor 310 senses an amount of light emitted from the LED devices 214 and transmits information relative to the amount of sensed light to the first PCB 135. In addition, the alignment groove 630 combined with the protrusion 180 of the mold frame 160 is formed on the second flexible PCB 600.

In an exemplary embodiment, a fixing member such as an adhesive tape (not shown) can be attached to a region other than a sensor area of an upper surface of the second flexible PCB 600, thereby increasing adhesion between the second flexible PCB 600 and the coupling portion 168 of the mold frame 160.

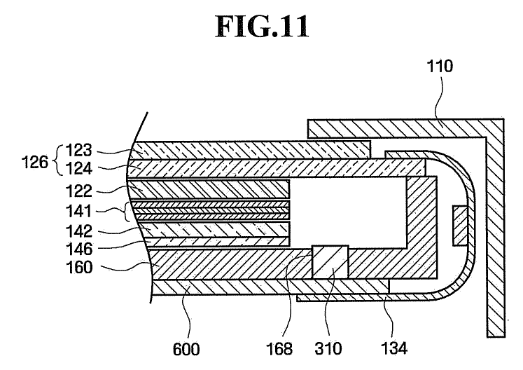

FIG. 11 is a cross-sectional view of an exemplary embodiment of a liquid crystal display including the mold frame shown in FIG. 9.

Referring to FIG. 11, the coupling portion 168 formed in the mold frame 160 is formed in as a hole to define a space for combining with the sensor 310. The flexible PCB 600 is combined with the rear surface of the mold frame 160 and the sensor 310 is combined with the coupling portion 168.

In addition, connecting pads (not shown) formed on the second flexible PCB 600 are connected to a connector (not shown) mounted on the first PCB 135 and transmit information relative to the amount of sensed light sensed by the sensor 310 to the first PCB 135.

As illustrated in the exemplary embodiment, the coupling portion 168 is formed on the rear surface of the mold frame 160, which is the same as in FIGS. 1-5, and the second flexible PCB 600 including the sensor 310 mounted thereon is combined with the coupling portion 168. The sensor 310 is completely accommodated by the coupling portion 168 such that an upper surface of the second flexible PCB 600 contacts the rear surface of the mold frame 160. Advantageously, an overall thickness and volume of the LCD is reduced.

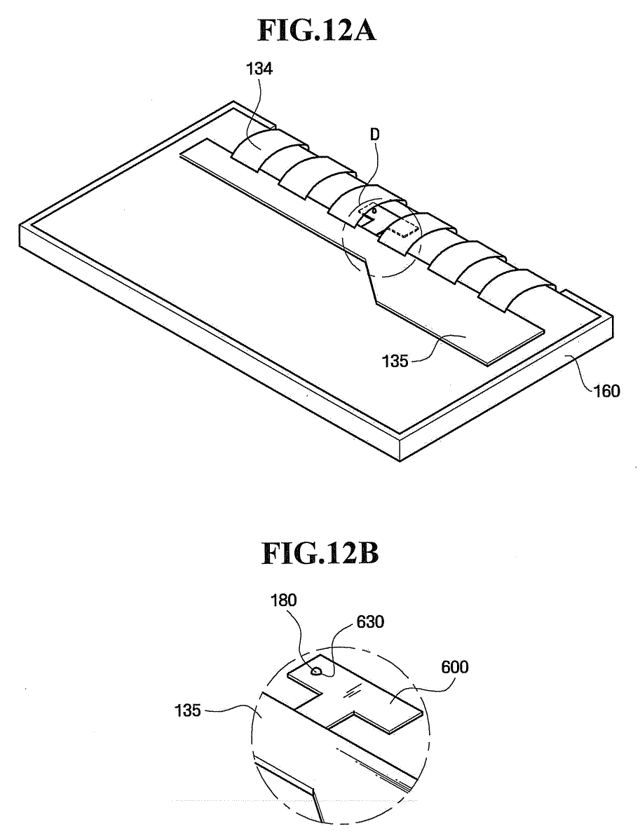

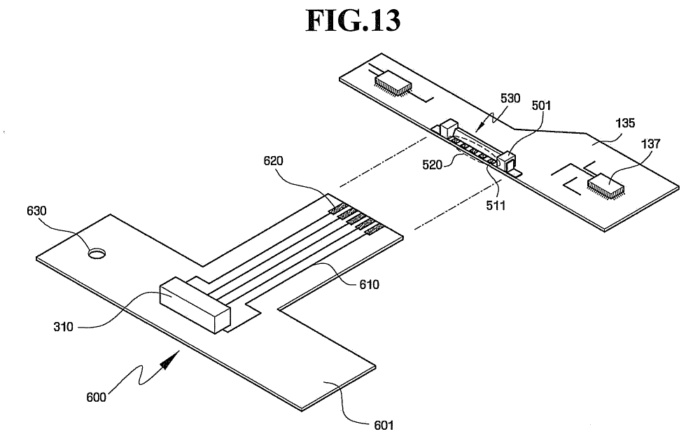

FIGS. 12A and 12B is a rear perspective view illustrating an mold frame and the second flexible printed circuit board shown in FIG. 9 in an assembled state, and FIG. 13 is a rear perspective view portion “D” of FIG. 12.

Referring to FIGS. 12A and 12B and FIG. 13, the second flexible PCB 600 is combined with the coupling portion 168 of the mold frame 160. The sensor 310 is mounted on the second flexible PCB 600. Connecting pads 620 formed on the second flexible PCB 600 are connected to a connector 530 of the first PCB 135, so that information including the amount of light emitted from R, G and B LED devices sensed by the sensor 310, is transmitted to the first PCB 135. Sensor driver chips 137 driving the sensor 310 are mounted on the first PCB 135.

The second flexible PCB 600 includes conductor patterns formed on a base film 601. The base film 601 may be made of a flexible insulating material, such as polyimide. The conductor patterns include wire patterns 610 and the connecting pads 620, which are substantially the same as described in FIG. 5. The wire patterns 610 include a plurality signal lines forming a part of a predetermined circuit. The connecting pads 620 are formed at a distal end of the base film 601 opposing the sensor 310.

As in the illustrated embodiment, the conductor patterns including the wire patterns 610 and connecting pads 620 are integrally formed with the second flexible PCB 600, unlike the embodiment illustrated in FIG. 5. As used herein, “integrally” is used to indicate formed as a single piece or element rather than combining separate elements. FIG. 5 includes a separate connecting element (e.g., the first flexible PCB 400) connecting the first and second PCB 135 and 300. In contrast, FIG. 9 illustrates the second PCB 600 including the connecting element (e.g., wire patterns 610 and connecting pads 620), and the connecting element of the second PCB 600 is connected to the first PCB 135. Advantageously, the second PCB 600 including both the sensor 310 and a connecting element 610 and 620 further reduces a number of components of the LCD and costs associated with assembling the LCD.

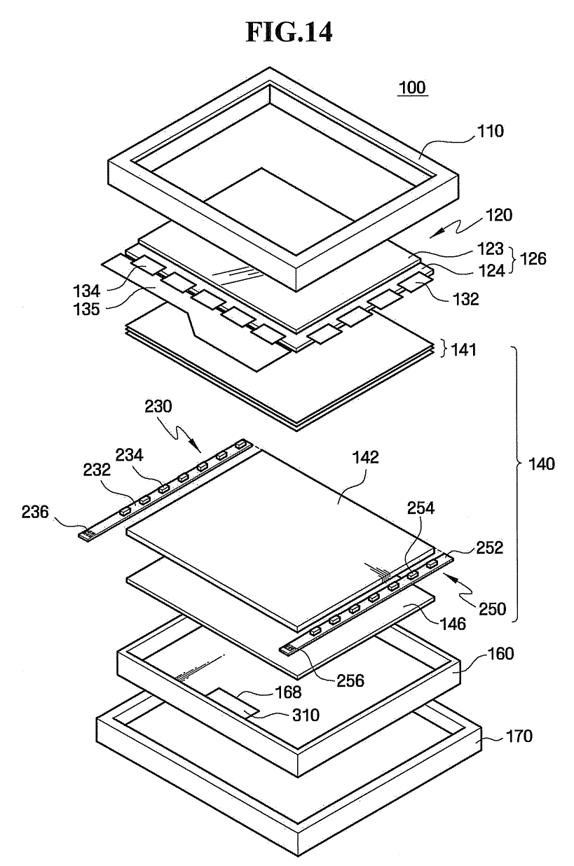

While the LED assembly 210 disposed at sidewalls of the light guiding plate 142 facing the first PCB 135 has been illustrated in the above description with reference to FIG. 1, the invention is not limited to the illustrated LED assembly. Alternatively, a first LED assembly and a second LED assembly may be disposed at sides of a light guiding plate 142 (e.g., opposing sides of the light guiding plate 142), as shown in FIG. 14.

FIG. 14 is an exploded perspective view of another exemplary embodiment of a liquid crystal display according to the present invention. Components having the same function for describing the previous embodiments are respectively identified by the same reference numerals, and their repetitive description will be omitted.

Referring to FIG. 14, a first LED assembly 230 is disposed at a first sidewall of a light guiding plate 142 which does not correspond to the first PCB 135 and a second LED assembly 250 is disposed at a second sidewall of a light guiding plate 142, the second sidewall facing the first sidewall of the light guiding plate 142.

The first LED assembly 230 includes a first flexible PCB 232, a plurality of first LED devices 234 disposed on an upper surface of the first flexible PCB 232, and a first connection terminal 236 formed at an end of the first flexible PCB 232 and connected to the first PCB 135. The second LED assembly 250 includes a second flexible PCB 252, a plurality of second LED devices 254 disposed on an upper surface of the second flexible PCB 252, and a second connection terminal 256 formed at an end of the second flexible PCB 252 and connected to the first PCB 135. In an exemplary embodiment, in order to implement an LCD having uniform brightness, the first and second LED devices 234 and 254 may be substantially equally spaced apart from one another, respectively. The first and second connection terminals 236 and 256 re disposed at ends of the first and second flexible printed circuit boards 232 and 252 corresponding to the first printed circuit board 135.

As in the exemplary embodiments of the backlight assembly, the liquid crystal display including the backlight assembly and method thereof, it is possible to reduce an overall thickness and volume of the liquid crystal display by forming a coupling portion on a rear surface of a mold frame, which can be combined with a sensor.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present exemplary embodiments be considered in all respects as illustrative and not restrictive, reference being made to the appended claims rather than the foregoing description to indicate the scope of the invention.

What is claimed is:

1. A backlight assembly comprising:
a light emitting diode (“LED”) assembly including a plurality of LED devices;
a mold frame receiving a light guiding plate and including a coupling portion disposed at a side of a rear surface of the mold frame; and
a sensor combined with the coupling portion and sensing an amount of light emitted from the plurality of LED devices.

2. The backlight assembly of claim 1, wherein the plurality of LED devices comprises R, G, and B (Red, Green and Blue) LED devices.

3. The backlight assembly of claim 1, wherein the sensor is disposed on a first printed circuit board (“PCB”) electrically connected to the LED assembly through a first flexible printed circuit board (“PCB”).

4. The backlight assembly of claim 3, wherein the coupling portion has a stepped configuration defining a space accommodating a combination of the first PCB and the sensor and the rear surface of the mold frame coincides with a rear surface of the first PCB.

5. The backlight assembly of claim 1, wherein the sensor is disposed on a second printed circuit board (“PCB”) directly electrically connected to the LED assembly.

6. The backlight assembly of claim 5, wherein the coupling portion has a stepped configuration defining a space accommodating a combination of the second PCB and the sensor and the rear surface of the mold frame contacts an upper surface of the second PCB.

7. The backlight assembly of claim 1, wherein the sensor is disposed on a second flexible printed circuit board (“PCB”).

8. The backlight assembly of claim 7, wherein a protrusion protruding from the rear surface of the mold frame is disposed adjacent to a side of the coupling portion.

9. The backlight assembly of claim 8, wherein a height of the protrusion is substantially same as a thickness of the second flexible PCB.

10. The backlight assembly of claim 8, wherein the second flexible PCB includes an alignment groove disposed corresponding to the protrusion of the mold frame and configured to be combined with the protrusion.

11. The backlight assembly of claim 1, wherein the LED assembly is disposed at one side of the light guiding plate which does not correspond to the coupling portion of the mold frame.

12. The backlight assembly of claim 1, wherein the LED assembly is disposed at more than one side of the light guiding plate which do not correspond to the coupling portion of the mold frame.

13. A liquid crystal display (“LCD”) comprising:
an LCD panel assembly including an LCD panel displaying image information and a first printed circuit board (“PCB”) connected to the LCD panel and providing the image information to the LCD panel;
an LED assembly providing light to the LCD panel and including a plurality of light emitting diodes (“LED”) devices;
a light guiding plate providing a propagation path of the light;
a mold frame receiving the light guiding plate and including a coupling portion disposed at a side of a rear surface of the mold frame; and
a sensor combined with the coupling portion, sensing an amount of the light emitted from the plurality of LED devices, the amount of sensed light being transmitted to the first PCB.

14. The LCD of claim 13, wherein the coupling portion is formed at a region of the mold frame other than an area corresponding to an active area of the LCD panel.

15. The LCD of claim 13, wherein the sensor is disposed on a second printed circuit board (“PCB”) separate from the first PCB.

16. The LCD of claim 13, wherein the sensor is disposed on the first PCB.

17. The LCD of claim 13, wherein the sensor is disposed on a second flexible printed circuit board (“PCB”).

18. The LCD of claim 17, wherein the second flexible PCB includes an alignment groove disposed corresponding to the protrusion of the mold frame and configured to be combined with the protrusion.

19. The LCD of claim 17, wherein the second flexible PCB is combined with the coupling portion.

20. A method of forming a backlight assembly, the method comprising:
forming a light emitting diode (“LED”) assembly including a plurality of LED devices;
forming a mold frame including a hole disposed at an edge of the mold frame; and
disposing a sensor in the hole of the mold frame and combining the sensor with the mold frame, the sensor sensing an amount of light emitted from the plurality of LED devices.
